(19) United States
(12) Patent Application Publication
(10) Pub. No.: US 2003/0168228 A1
(43) Pub. Date: Sep. 11, 2003

(54) Cable having annularly arranged set of twisted pair wires

(75) Inventors: Eric Eichelberger, Tualatin, OR (US); Chanramany Riel, Vancouver, WA (US); Kristin Ngo, Portland, OR (US)

Correspondence Address: BENNET K. LANGLOTZ, BOX 759, GENOA, NV, 89411, US

(73) Assignee: Precision Interconnect Corporation

(21) Appl. No.: 09/900,816

(22) Filed: Jul. 6, 2001

(51) Int. Cl. H01B 11/02

(52) U.S. Cl. 174/27

(57) ABSTRACT

A cable assembly has a central core element with a central conductor surrounded by an insulating core sheath having a uniform wall thickness. A plurality of twisted pairs of wires surround the core element, abutting each other and the core to form a tube concentric with an axis defined by the center of the core, a conductive shield layer surrounds the twisted pairs and is uniformly spaced apart therefrom.

### FIELD OF THE INVENTION

This invention relates to multiple-wire cables, and more particularly to high frequency transmission cables.

### BACKGROUND AND SUMMARY OF THE INVENTION

Certain demanding applications require miniaturized multi-wire cable assemblies. To avoid undesirably bulky cables when substantial numbers of conductors are required, very fine conductors are used. To limit electrical noise and interference at high signal frequencies, conductors are generally shielded. A typical approach employs fine coaxial wires, which are bundled in a cable. Each wire includes its own shield, which provides suitable protection against interference at high frequencies.

While adequate, multiple coaxial assemblies have several disadvantages. The manufacturing cost of fine coaxial wiring is higher than is acceptable for many applications. The mode of terminating very fine coaxial wire is complex and expensive, and the overall size of a coax bundle can be too large for some applications due to the required spacing between central conductors and outer shields.

For low-voltage differential signal (LVDS) communication, twisted pair wiring has been used effectively. However, for the finest gauge wires and for high frequencies required in certain applications, twisted pair wires have critical limitations. One problem is that when twisted pairs are bundled together and surrounded by a suitable conductive shield layer, they have different electrical characteristics with respect to the shield. Some pairs will inevitably be closer to the shield than are others, resulting in common mode impedance differences or signal skew as signals via different pairs arrive at different times. Such skew limits usable signal rates, a particular concern with very small conductors needed for slim, flexible cables requiring a multitude of lines.

The present invention overcomes the limitations of the prior art by providing a cable assembly. The cable assembly has a central core element with a central conductor surrounded by an insulating core sheath having a uniform wall thickness. A plurality of twisted pairs of wires surround the core element, abutting each other and the core to form a tube concentric with an axis defined by the center of the core, a conductive shield layer surrounds the twisted pairs and is uniformly spaced apart therefrom.

### BRIEF DESCRIPTION OF THE DRAWINGS

FIG. 1 is a cut-away perspective view of a cable assembly according to a preferred embodiment of the invention.

FIG. 2 is a cut-away perspective view of a cable assembly component according to the preferred embodiment of the invention. FIG. 3 is a sectional end view of a cable assembly according to the preferred embodiment of the invention.

### DETAILED DESCRIPTION OF A PREFERRED EMBODIMENT

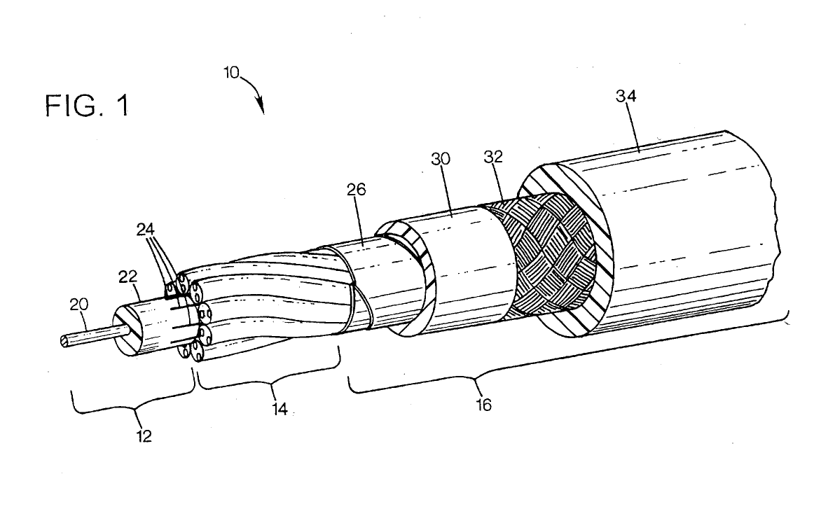

FIG. 1 shows a flexible cable assembly 10 for high frequency signal or high speed data transmission. The cable includes a core 12, a set of twisted pair wires 14 helically wrapped about the core, and an outer sheath portion 16.

The core has a central conductor 20 surrounded by a core sheath 22. In the preferred embodiment, the central conductor is a 22 AWG single strand copper conductor, and the core sheath is a polymer (such as PVC) sheath with a uniform wall thickness of 0.014 inch. The uniformity of the wall thickness ensures concentricity of the conductor and the outer surface of the sheath.

The twisted pair wires 14 each include two helically twisted wires insulated from each other and encased in a conformal pair sheath as will be discussed below. Nine twisted pairs are provided, although this number may vary without limitation depending on the needs of the particular application. Each twisted pair sheath has a diameter of 0.030 inch, which allows each to abut the surface of the core throughout its entire length, and to abut each adjacent pair sheath. This ensures that each pair is kept at the same controlled distance from the core conductor, and from the adjacent pairs. When it is indicated that the pairs abut each other, this means that their outer sheaths abut each other. This also includes instances in which the pairs abut spacers arranged between them, so that the pairs are evenly spaced about the core, whether by the contact of their own sheaths, or by contact of their sheaths with common spacers.

In the preferred embodiment, the pairs wrap helically about the core. The wrap angle results in each pair making one full wrap about the core over a cable length of 2.0 inches. The wrap angle may vary slightly to accommodate variations in pair sheath diameter and core sheath diameter. If the pairs were sized to abut each other and the core, a slight variance of the pair diameter above nominal, or of the core diameter below nominal would cause at least one pair to be forced away from abutment with the core. However, an intended slight under-sizing of the pairs (and/or over-sizing of the core) prevents this problem. In this case, the expected gapping between pairs that would occur if they were parallel to the core is prevented by helically wrapping them. The degree of the wrap angle is in effect determined by the geometry of the pairs and core, with the wrap angle increasing (and the length for one full helical revolution of a pair decreasing) for smaller pair diameters.

Several tension cords 24 also surround the core. The cords are sized to occupy at least some of the interstices formed between an adjacent pair of pairs and the underlying core surface. Such interstices are essentially elongated tubes having somewhat triangular cross sections, and which helically wrap about the core at the wrap angle of the pairs. The cords are small unbraided lines of high strength non-conductive material (such as nylon) having multiple filaments, and are wrapped about the core with adequate tension to slightly compress the core, and to maintain some residual tension after manufacturing. This residual tension ensures that the tensile forces generated in response to stretching of the finished cable are borne by and resisted by the cords, and not by the more delicate twisted pairs. Essentially, the preferred embodiment is rated to withstand a tension of 50 pounds, and the cords ensure that under this tension, the cable does not stretch excessively.

The twisted pairs are helically wrapped by a single band of thin tape 26 that holds the pairs against the core during intermediate manufacturing stages, and throughout the life of the cable. The tape is slightly tensioned to bias the pairs against the core, and to prevent gapping when the cable is flexed during usage. The tape is a low-friction fluoropolymer film having a thickness of 0.004 inch. With a tape width of 0.50 inch, and an outside diameter of the pair and core bundle of 0.125 inch, the tape wraps with approximately 3 turns to the inch, with a 30% overlap between wraps.

The tape-wrapped bundle is encased in a spacer sheath 30 formed of PVC or other polymer, with a wall thickness of 0.014 inch. The wall thickness is held consistent, so that the spacer surface is concentric with the annulus formed by the pairs, and with the core conductor. The wall thickness of the spacer sheath is the same as that of the core sheath 22, so that the pairs are equally spaced between the core conductor surface and the surface of the spacer sheath. The spacer sheath is preferably co-extruded over the bundle, although it may be pre-formed, and the bundle drawn into its bore.

A conductive shield 32 wraps closely about the spacer sheath 26. The shield is a braided wrap of 38 AWG copper wire, with a specified coverage of at least 90%. With the controlled dimensions of the spacer sheath, the shield is spaced equally from each wire pair.

An outer sheath 34 closely surrounds the shield, and provides protection against damage. The outer sheath is formed of flexible polyurethane, and is preferably co-extruded about the shield. The finished cable has an exterior diameter of 0.23 inches.

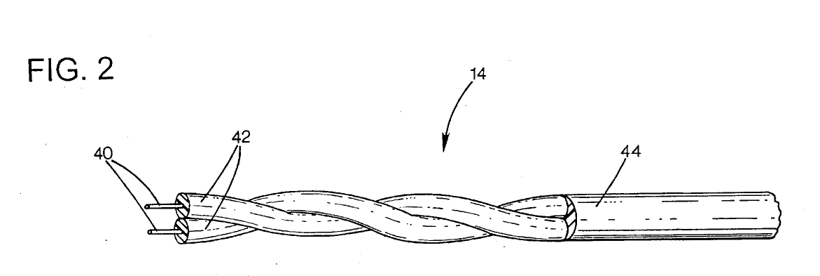

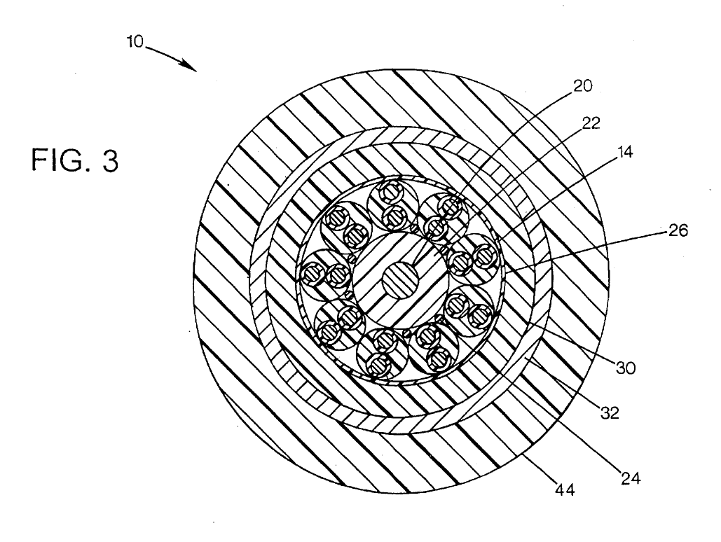

FIG. 2 shows a single twisted pair 14 in detail. Each wire of the pair has a conductor 40 of 32 AWG copper, surrounded by an insulating sheath 42 of 0.003 inch wall thickness fluropolymer material. Each sheathed wire has an outside diameter of 0.015 inch. The wires are wound in a helix with a twist rate of 3 full turns per inch. In some applications, the twist rates may be engineered at different rates to avoid unwanted interference between adjacent pairs. In alternative embodiments, the twist rates may alternate between two different values so that adjacent pairs do not interact. The wires are in contact with each other along their entire length, on an axis. In the preferred embodiment, he wires are encased in a cover 44 of polymeric material. The cover is co-extruded about the wires, with an outside diameter of 0.045 inch, or 1½ times the diameter of the pairs.

As illustrated and described in the preferred embodiment, it has been found that the cable enables data rates of 100 to 655 Mbits/sec. This is for cables with a length of 18 to 120 inches. While the very fine wires employed are needed to ensure flexibility for applications where a connected component must be moved comfortably (such as for input devices or transducers connected to computing equipment or electronic instruments), it is believed that longer cable lengths required for other purposes will require larger conductors. Although these may employ the concepts disclosed and illustrated for the preferred embodiment, they are less suited where repeated flexibility is needed.

While the above is discussed in terms of preferred and alternative embodiments, the invention is not intended to be so limited. For instance, the illustrated cable may be used as a component of a larger cable, with multiple instances of the illustrated cable bundled side-by-side about a large central core. This would provide more channels, without the increased bulk that would result from arranging a very large number of wires about a single large core.

1. A cable assembly comprising:
a central core element;
a plurality of twisted pairs of wires surrounding the core element; and
the twisted pairs evenly spaced with respect to each other to form a tube about the core.

2. The assembly of claim 1 wherein the twisted pairs abut the core.

3. The assembly of claim 1 wherein the twisted pairs abut each other.

4. The assembly of claim 1 wherein the core includes a central conductor surrounded by an insulating core sheath.

5. The assembly of claim 3 wherein the core sheath has a uniform wall thickness, such that the twisted pairs are uniformly spaced apart from the central conductor.

6. The assembly of claim 1 wherein each adjacent pair of twisted pairs and the core define an elongated interstice, and including a flexible tension member occupying the interstice.

7. The assembly of claim 1 including an outer sheath surrounding the twisted pairs, and a conductive shield layer surrounding the outer sheath.

8. The assembly of claim 7 wherein the outer sheath has a uniform wall thickness, such that the twisted pairs are uniformly spaced apart from the shield layer.

9. The assembly of claim 1 wherein the tube formed by the twisted pairs is concentric with an axis defined by the center of the core.

10. A cable assembly comprising:
a central core element;
a plurality of twisted pairs of wires surrounding the core element; and
the twisted pairs evenly spaced with respect to an axis defined by the core to form a tube about the core.

11. The assembly of claim 10 wherein the tube formed by the twisted pairs is concentric with an axis defined by the center of the core.

12. The assembly of claim 10 wherein the twisted pairs abut each other.

13. The assembly of claim 10 wherein the twisted pairs are evenly spaced with respect to each other.

14. The assembly of claim 10 wherein the core includes a central conductor surrounded by an insulating core sheath having a uniform wall thickness, such that the twisted pairs are uniformly spaced apart from the central conductor.

15. The assembly of claim 10 wherein each adjacent pair of twisted pairs and the core define an elongated interstice, and including a flexible tension member occupying the interstice.

16. The assembly of claim 10 including an outer sheath surrounding the twisted pairs.

17. The assembly of claim 16 including a conductive shield layer surrounding the outer sheath.

18. The assembly of claim 17 wherein the outer sheath has a uniform wall thickness, such that the twisted pairs are uniformly spaced apart from the shield layer.

19. The assembly of claim 10 wherein each twisted pair is encapsulated to form a cylindrical outer surface.

20. A cable assembly comprising:
a central core element having a central conductor surrounded by an insulating core sheath having a uniform wall thickness;
a plurality of twisted pairs of wires surrounding the core element;
the twisted pairs evenly spaced with respect to each other and with respect to the core to form a tube concentric with an axis defined by the center of the core; and
a conductive shield layer surrounding the twisted pairs and uniformly spaced apart therefrom.
